(19) United States
(12) Patent Application Publication
(10) Pub. No.: US 2023/0321657 A1
(43) Pub. Date: Oct. 12, 2023

(54) SPECIMEN ANALYSIS CARTRIDGE AND MANUFACTURING METHOD FOR THE SAME

(71) Applicants: SYSMEX CORPORATION, Kobe-shi (JP); Creative Nanosystems Corporation, Kobe-shi (JP); KYORITSU CHEMICAL & CO., LTD., Tokyo (JP)

(72) Inventors: Kazuyoshi HORII, Kobe-shi (JP); Shun NAKAMOTO, Kobe-shi (JP); Koki HOSHIKAWA, Kobe-shi (JP); Katsunori OSHIMA, Kobe-shi (JP); Koji TSUJITA, Kobe-shi (JP); Wataru KUZUTA, Kobe-shi (JP); Tomoyuki HOSOYA, Kobe-shi (JP); Yo TODA, Kisarazu-shi (JP); Masahiro MORIMOTO, Kisarazu-shi (JP)

(73) Assignees: SYSMEX CORPORATION, Kobe-shi (JP); Creative Nanosystems Corporation, Kobe-shi (JP); KYORITSU CHEMICAL & CO., LTD., Tokyo (JP)

(21) Appl. No.: 18/297,031

(22) Filed: Apr. 7, 2023

(30) Foreign Application Priority Data
Apr. 8, 2022 (JP) 2022-064288

(51) Int. Cl. B01L 3/00

(52) U.S. Cl. CPC B01L 3/502746; B01L 2300/0877

(57) ABSTRACT

Disclosed is a specimen analysis cartridge that includes: a first base having a micro flow path formed in at least one surface; a second base disposed so as to oppose a surface at which the micro flow path of the first base is formed; and a photocurable resin layer for adhering the first base and the second base to each other, and the first base and the second base each contain at least one of cycloolefin polymer and cycloolefin copolymer.

### CROSS REFERENCE TO RELATED APPLICATIONS

This application claims priority from prior Japanese Patent Application No. 2022-064288, filed on Apr. 8, 2022, entitled “SPECIMEN ANALYSIS CARTRIDGE AND MANUFACTURING METHOD FOR THE SAME”, the entire content of which is incorporated herein by reference.

### FIELD OF THE INVENTION

The present invention relates to a specimen analysis cartridge and a manufacturing method for the specimen analysis cartridge.

### BACKGROUND OF THE INVENTION

A method for analyzing a test substance in a specimen by using a specimen analysis cartridge having a micro flow path formed at a surface of a base, has been known. In such an analysis method, various reactions can be caused and detection can be made on the specimen analysis cartridge by introducing a specimen or a reagent into the flow path

For example, Japanese Laid-Open Patent Publication No. 2018-009952 discloses a detection apparatus in which a magnetic particle is transferred through a plurality of chambers in a cartridge which includes the plurality of chambers and a channel connecting between the plurality of chambers, and the magnetic particle is thus caused to carry a complex of a test substance and a labelling substance, and the test substance is detected on the basis of the labelling substance in the complex.

Furthermore, for example, a specimen analysis cartridge in which an open flow path is formed at a surface of a base and the open flow path is sealed by a flat plate, has been known as a specimen analysis cartridge.

For example, U.S. Pat. No. 9,555,411 discloses cycloolefin polymer, cycloolefin copolymer, and the like as a material that can be used for a base of a specimen analysis cartridge.

A base used for a specimen analysis cartridge is required to have excellent transparency and chemical resistance. The present inventors have found as a result of thorough research that a specimen analysis cartridge containing a material which satisfies such requirements is likely to cause liquid leakage, more specifically, the specimen analysis cartridge is likely to cause liquid leakage in a case where the specimen analysis cartridge is heated to about 40° C. for causing reaction between a test substance and a reagent.

### SUMMARY OF THE INVENTION

The scope of the present invention is defined solely by the appended claims, and is not affected to any degree by the statements within this summary.

A specimen analysis cartridge according to the present invention includes a first base having a micro flow path formed in at least one surface; a second base disposed so as to oppose a surface at which the micro flow path of the first base is formed; and a photocurable resin layer for adhering the first base and the second base to each other. The first base and the second base each contain at least one of cycloolefin polymer and cycloolefin copolymer.

A manufacturing method for manufacturing the specimen analysis cartridge according to the present invention includes: applying a photocurable resin composition to the first base by an inkjet method; adhering the second base to a surface of the first base to which the photocurable resin composition is applied; and applying light to the photocurable resin composition to form the photocurable resin layer.

### BRIEF DESCRIPTION OF THE DRAWINGS

FIG. 1 is a schematic cross-sectional view of a specimen analysis cartridge A of a first embodiment;

FIG. 2 is a schematic cross-sectional view of a specimen analysis cartridge B of a second embodiment;

FIG. 3 is a schematic plan view of a specimen analysis cartridge 100 of a third embodiment;

FIG. 4A is a schematic cross-sectional view of the specimen analysis cartridge 100 of the third embodiment;

FIG. 4B is a schematic cross-sectional view of the specimen analysis cartridge 100 of the third embodiment;

FIG. 5A is a schematic perspective view of an example of a detection apparatus for analyzing a specimen by using the specimen analysis cartridge according to the present embodiment;

FIG. 5B is a schematic perspective view of an example of the detection apparatus for analyzing a specimen by using the specimen analysis cartridge according to the present embodiment; and

FIG. 6 illustrates an example of a manufacturing method for manufacturing the specimen analysis cartridge according to the present embodiment.

### DETAILED DESCRIPTION

Embodiments (hereinafter, each referred to as “present embodiment”) according to the present disclosure will be described below in detail with reference to the drawings. However, the present disclosure is not limited to the embodiments, and various modifications can be made without departing from the gist of the present disclosure. In the following drawings, the same or similar components are denoted by the same or similar reference characters. The drawings are schematic, and do not necessarily represent actual dimensions, proportions, and the like. Throughout the drawings, mutual relationships in dimensions or proportions may be different.

### Specimen Analysis Cartridge

A specimen analysis cartridge of the present embodiment includes a first base having a micro flow path formed in at least one surface, a second base disposed so as to oppose a surface at which the micro flow path of the first base is formed, and a photocurable resin layer for adhering the first base and the second base to each other, and the first base and the second base each contain at least one of cycloolefin polymer and cycloolefin copolymer.

The specimen analysis cartridge of the present embodiment is inserted in a specimen analyzer and is used for detecting and/or quantitatively determining a test substance contained in a specimen. Each component of the specimen analysis cartridge will be described below in detail.

### First Base

The first base has a micro flow path formed in at least one surface. The first base may have not only the micro flow path but also a recess such as a chamber which does not have a flow-path-like shape, a through hole penetrating through the first base, and a mechanism (hereinafter, referred to as “unsealing mechanism”) that is pressed to form a through hole as disclosed in Japanese Laid-Open Patent Publication No. 2018-72131 or US Patent Application Publication No. 2018/117583. The contents of Japanese Laid-Open Patent Publication No. 2018-72131 and US Patent Application Publication No. 2018/117583 are incorporated herein by reference.

In the present specification, the micro flow path refers to a flow path in which at least one of the width and the depth of the recess is not greater than a μm order, i.e., is less than 1.0 mm. In the first base or the second base, “having a micro flow path formed” means that a groove in which at least one of the width and the depth is less than 1.0 mm is formed. Furthermore, the term “micro chamber” means a chamber having a depth of less than 1.0 mm.

Although the first base is just required to have the micro flow path formed in at least one surface, the first base typically has a through hole serving as an introduction inlet for a specimen, the micro flow path, and a chamber or a micro chamber (hereinafter, in a case where “chamber” is merely referred to, the chamber also implies a micro chamber unless otherwise specified). The first base may further include a through hole serving as an introduction inlet for a reagent used for analyzing a specimen, and an unsealing mechanism. Unit operations such as chemical reaction and stirring are performed in the micro flow path and/or the chamber, and the specimen is analyzed on the specimen analysis cartridge.

The minimal flow path width of the micro flow path formed in the first base is, for example, less than 1.0 mm, preferably not greater than 500 μm, more preferably not greater than 300 μm, even more preferably not greater than 200 μm, and still more preferably not greater than 150 μm. In a case where the minimal flow path width of the micro flow path is in the above-described range, a specimen and a reagent can efficiently pass through the flow path, and, furthermore, the specimen analysis cartridge can be made smaller. The lower limit value of the minimal flow path width of the micro flow path is not particularly limited, and is, for example, 1 μm, 5μm, 10 μm, 50 μm, or 100 μm. The minimal flow path width of the micro flow path may be in a range obtained by discretionarily combining the above-described upper limit value and lower limit value with each other.

The minimal flow path depth of the micro flow path is, for example, less than 1.0 mm, preferably not greater than 500 μm, more preferably not greater than 300 μm, even more preferably not greater than 200 μm, and still more preferably not greater than 150 μm. In a case where the minimal flow path depth of the micro flow path is in the above-described range, a specimen and a reagent can efficiently pass through the flow path. The lower limit value of the minimal flow path depth of the micro flow path is not particularly limited, and is, for example, 1.0 μm, 5.0 μm, 10 μm, 50 μm, or 100 μm. The minimal flow path depth of the micro flow path may be in a range obtained by discretionarily combining the above-described upper limit value and lower limit value with each other.

The micro flow path typically has a function of connecting the chambers to each other and a function of connecting between the introduction inlet for a specimen and the chambers. The micro flow path may further have other functions including a function of assisting in separating a specimen. The micro flow path and the chamber formed in the first base function as the micro flow path and the chamber by adhering the second base to the surface at which the micro flow path and the chamber of the first base are formed and thus sealing openings.

The micro flow path and the chamber are just required to be formed in at least one surface of the first base, and may be formed merely in one surface or may be formed in each of both surfaces. The micro flow path and the chamber may be formed merely in one surface from the viewpoint of reducing manufacturing cost. The micro flow paths and the chambers may be formed in both surfaces from the viewpoint of enhancing analysis accuracy and efficiency.

The first base contains at least one of cycloolefin polymer and cycloolefin copolymer. The cycloolefin polymer is a polymer obtained by using a cycloolefin as a monomer, and is substantially a polymer formed of structural units each having an alicyclic structure. The cycloolefin copolymer is a polymer obtained by using a cycloolefin and another monomer, and is a polymer that includes structural units each having an alicyclic structure.

As long as the cycloolefin copolymer contained in the first base is a copolymer that includes structural units each having an alicyclic structure, the cycloolefin copolymer is not particularly limited. However, the cycloolefin copolymer may be a copolymer in which a proportion of monomer units (structural units each having an alicyclic structure) derived from a cycloolefin is preferably not less than 30 mol %, more preferably not less than 50 mol %, even more preferably not less than 70 mol %, and still more preferably not less than 80 mol % with respect to all the monomer units. Examples of the monomer unit other than the cycloolefin in the cycloolefin copolymer include olefins such as ethylene, propylene, and butadiene.

The cycloolefin polymer and the cycloolefin copolymer contained in the first base have high transparency. In a case where the cycloolefin polymer or the cycloolefin copolymer is formed into a plate having a thickness of 3 mm, visible light (400 to 800 nm) transmittance is preferably not less than 70%, more preferably not less than 80%, and even more preferably not less than 85%. The upper limit value of the visible light transmittance is not particularly limited, and may be, for example, 100%, 99%, or 95%.

The cycloolefin polymer and the cycloolefin copolymer contained in the first base have high chemical resistance. Specifically, water absorption measured in accordance with ASTM D570 is preferably not greater than 0.10%, more preferably not greater than 0.08%, and even more preferably not greater than 0.05%. The lower limit value of the water absorption is not particularly limited, and may be 0%, 0.001%, or 0.003%.

The cycloolefin polymer and the cycloolefin copolymer contain structural units each having an alicyclic structure, and thus have high transparency and high chemical resistance (that is, reactivity to chemicals is low). Therefore, in a case where the first base contains at least one of the cycloolefin polymer and the cycloolefin copolymer, the specimen analysis cartridge can have high chemical resistance. Thus, a reagent can be sealed in the specimen analysis cartridge and stably stored for a long time period. Furthermore, various reagents can be used for analyzing specimens. In a case where the first base contains at least one of the cycloolefin polymer and the cycloolefin copolymer, light can be applied to a specimen or light emitted by a specimen can be detected while the specimen is held in the specimen analysis cartridge. That is, while a specimen is held in the specimen analysis cartridge, analysis such as fluorescence analysis and chemiluminescent immunoassay in which light (in particular, visible light) is used, can be performed with high accuracy.

The size of the first base is not particularly limited. The size of the first base may be changed as appropriate according to the size of a specimen analyzer into which the specimen analysis cartridge is inserted. However, the lengths of the major axis and the minor axis are, for example, not less than 5.0 cm and not greater than 30 cm. The shape of the first base is not particularly limited, and may be, for example, a disk-like shape or a polygonal-plate-like shape.

The thickness of the first base is not particularly limited, and is, for example, not less than 0.50 mm and not greater than 1.0 cm, and preferably not less than 0.75 mm and not greater than 5.0 mm.

### Second Base

The second base is adhered through a photocurable resin layer described below to a surface at which the micro flow path of the first base is formed. That is, the second base acts as a cover for sealing an opening of the micro flow path formed at the first base. By adhering the first base and the second base to each other, the micro flow path as a groove formed at the first base functions as a flow path.

The second base may have a micro flow path formed therein or may not have a micro flow path formed therein. Similarly, the second base may have a recess such as a through hole and a chamber other than the flow path.

The second base contains at least one of cycloolefin polymer and cycloolefin copolymer. The cycloolefin polymer and the cycloolefin copolymer that can be contained in the second base are similar to those of the first base. The second base may be formed of the same material as that of the first base or may be formed of a material different from that of the first base.

In a case where the second base as well as the first base contains at least one of the cycloolefin polymer and the cycloolefin copolymer, transparency and chemical resistance of the specimen analysis cartridge can be further enhanced.

The size of the second base is not particularly limited. The size of the second base may be changed as appropriate according to the size of a specimen analyzer into which the specimen analysis cartridge is inserted. However, the lengths of the major axis and the minor axis are, for example, not less than 5.0 cm and not greater than 30 cm. The shape of the second base is not particularly limited, and may be, for example, a disk-like shape or a polygonal-plate-like shape. The size and the shape of the second base may be the same as the size and the shape of the first base.

The thickness of the second base is not particularly limited, and is, for example, not less than 10 μm and not greater than 1.0 cm, and preferably not less than 50 μm and not greater than 5.0 mm.

In the present embodiment, the second base may be a film. In this case, the second base does not have a micro flow path and a chamber formed therein, and the second base exclusively acts to seal the micro flow path, the through hole, and/or the chamber of the first base. However, the second base may have a through hole formed therein. In this case, the thickness of the second base is, for example, not less than 10 μm and is less than 0.50 mm, and preferably not less than 50 μm and not greater than 0.30 mm.

The second base may have the same structure as the first base. That is, the second base may have a micro flow path formed in a surface opposing the first base, and may discretionarily have a chamber and/or a through hole and/or an unsealing mechanism. In this case, the thickness of the second base is, for example, not less than 0.50 mm and not greater than 1.0 cm, and preferably not less than 0.75 mm and not greater than 5.0 mm.

At least a part of the second base is just required to be disposed so as to oppose the surface at which the micro flow path of the first base is formed. For example, in a case where the micro flow path is formed merely on one surface of the first base, the second base may be disposed merely on the surface at which the micro flow path is formed, or the second bases may be disposed on both surfaces of the first base. In a case where the micro flow paths are formed on both surfaces of the first base, the second base may be disposed merely on one of the surfaces, or the second bases may be disposed on both the surfaces of the first base. The second base may be disposed so as to oppose a surface at which the micro flow path of the first base is not formed, or the second base may not necessarily be disposed on the surface at which the micro flow path of the first base is formed.

The second base need not necessarily be disposed on the entirety of the surface at which the micro flow path of the first base is formed, and may be disposed merely on a part of a portion at which the micro flow path is formed. When the total area of the surface of the first base on which the second base is disposed is 100%, an area occupied by the second base may be not less than 10% of the total area, and is preferably not less than 20%, 30%, 40%, 50%, 60%, or 70% thereof. Although the upper limit value of the proportion of the area occupied by the second base is not particularly limited, the upper limit value may be, for example, 100%, 99%, 95%, or 90%. The proportion of the area occupied by the second base may be in a range obtained by discretionarily combining the above-described upper limit value and lower limit value with each other.

In a case where the second base is not disposed at a portion at which the micro flow path, the through hole, and/or the chamber of the first base are formed, a third base different from the first base and the second base is preferably disposed at the portion. The third base will be described below.

In the present embodiment, the second base is disposed so as to oppose the portion at which the micro flow path and the chamber of the first base are formed, and the micro flow path and the chamber are covered by the second base. In a case where an unsealing mechanism is formed in the first base, the third base described below may be disposed so as to oppose a portion at which the unsealing mechanism is formed, and the unsealing mechanism may be covered by the third base.

### Photocurable Resin Layer

The photocurable resin layer is a layer for adhering the first base and the second base to each other. The cycloolefin polymer and the cycloolefin copolymer have high transparency and high chemical resistance. However, the cycloolefin polymer and the cycloolefin copolymer contain no polar groups or contain a small amount of polar groups. Therefore, it is difficult to adhere the first base and the second base by using an adhesive sheet having an adhesive (for example, acrylic adhesive or silicone-based adhesive) used conventionally for adhering bases of specimen analysis cartridges. That is, even if the bases each containing at least one of the cycloolefin polymer and the cycloolefin copolymer are adhered to each other by using an adhesive, adhesive strength is insufficient, and it is difficult to provide a specimen analysis cartridge having high durability against liquid leakage by using bases each containing the cycloolefin polymer and/or the cycloolefin copolymer.

Particularly, when a specimen is analyzed, the specimen analysis cartridge is heated to about 42° C. in order to cause stable reaction between a test substance in the specimen and a reagent containing a labelling substance. At this time, a gas phase portion in the specimen analysis cartridge is expanded by the heating, whereby a force for separating the two bases is applied to the specimen analysis cartridge, and liquid leakage is likely to occur. In a case where a specimen analysis cartridge is manufactured by adhering, by an adhesive, bases each containing at least one of cycloolefin polymer and cycloolefin copolymer to each other, since the adhesive has low heat resistance, an adhesive force between the bases is lowered under the heating condition, and liquid leakage is particularly likely to occur. Furthermore, it is difficult to precisely apply an adhesive merely to a portion other than a portion at which the micro flow path is formed when the adhesive is applied to the base at which the micro flow path is formed, so that a problem also arises that the micro flow path is clogged as a result of the adhesive being applied up to the inside of the micro flow path.

In order to overcome such a problem, the present inventors have found that, by adhering bases each containing at least one of cycloolefin polymer and cycloolefin copolymer to each other by photocurable resin, a specimen analysis cartridge having high durability against liquid leakage even under a heating condition for causing reaction between a test substance and a reagent, can be provided.

Unlike an adhesive, photocurable resin can exhibit high adhesive strength regardless of whether or not a material contained in a base has a polar group, and, furthermore, is unlikely to lower an adhesive force even under the heating condition. Furthermore, the viscosity of photocurable resin can be adjusted as appropriate. Therefore, in a case where photocurable resin is adjusted so as to have a proper viscosity, the photocurable resin can be applied to the first base or the second base by an inkjet method. Furthermore, photocurable resin has a higher curing speed than thermosetting resin. Accordingly, by using the photocurable resin, a portion at which a curable resin layer is to be formed can be precisely controlled. Thus, by adhering the first base and the second base by using photocurable resin, a specimen analysis cartridge that has high durability against liquid leakage and does not cause clogging of the micro flow path can be manufactured. In addition to the above-described matters, photocurable resin can form a curable resin layer without heating the bases. Therefore, photocurable resin is advantageous also in that, even when protein such as an antibody is on the base, the specimen analysis cartridge can be manufactured without causing thermal denaturation of the protein.

The photocurable resin layer is just required to be formed in at least a part of a portion at which the first base and the second base oppose each other, and the photocurable resin layer need not necessarily be disposed on the entire surface of the portion at which the first base and the second base oppose each other as long as an adhesive strength between the first base and the second base is maintained. On the surface at which the micro flow path of the first base is formed, the photocurable resin layer is disposed at a portion at which the micro flow path is not formed, and is not disposed at a portion at which the micro flow path is formed.

The photocurable resin layer acts to adhere the first base and the second base to each other. The 180° peel strength between the first base and the second base is preferably not less than 15 N/10 mm, more preferably not less than 20 N/10 mm, and even more preferably not less than 25 N/10 mm. In a case where the 180° peel strength is in the above-described range, the specimen analysis cartridge has further improved durability against liquid leakage. The upper limit value of the 180° peel strength between the first base and the second base is not particularly limited, and may be, for example, 100 N/10 mm, 80 N/10 mm, 60 N/10 mm, 50 N/10 mm, or 30 N/10 mm. Specifically, the 180° peel strength may be measured by a method described in examples. For example, the 180° peel strength may be adjusted so as to be in the above-described range by forming the photocurable resin layer with use of a photocurable resin composition described below.

The thickness of the photocurable resin layer is not particularly limited, and is, for example, not less than 1.0 μm and not greater than 100 μm, preferably not less than 1.2 μm and not greater than 50 μm, more preferably not less than 1.5 μm and not greater than 30 μm, and even more preferably not less than 2.0 μm and not greater than 20 μm. In a case where the thickness of the photocurable resin layer is in the above-described range, the photocurable resin layer can be more assuredly inhibited from being formed in the micro flow path, and generation of clogging of the micro flow path can be more effectively inhibited. For example, the thickness of the photocurable resin layer may be adjusted so as to be in the above-described range by controlling a viscosity of the photocurable resin composition, a pressing pressure in an adhering step in a manufacturing method described below, and an amount of the photocurable resin composition to be applied.

The photocurable resin layer is a layer containing photocurable resin. In the present specification, the photocurable resin contained in the photocurable resin layer implies not only photocurable resin having not been cured but also photocurable resin having been cured. The photocurable resin layer is preferably a layer containing acrylic resin and/or methacrylic resin (hereinafter, simply referred to as “(meth)acrylic resin”) as the photocurable resin, and is more preferably a layer containing a cured product of a photocurable resin composition which contains (a) acrylic oligomer and/or methacrylic oligomer (hereinafter, simply referred to as “(meth)acrylic oligomer”) having a weight-average molecular weight of not less than 2000, (b) acrylic monomer and/or methacrylic monomer (hereinafter, simply referred to as “(meth)acrylic monomer”), and (c) a photo radical polymerization initiator. Such a photocurable resin composition advantageously has such a viscosity that allows the photocurable resin composition to be applied to the base by an inkjet method, and has higher adhesiveness.

The (a) (meth)acrylic oligomer having a weight-average molecular weight of not less than 2000 has one or more (meth)acryloyl groups in a molecule. A molecular weight of the (meth)acrylate oligomer is preferably 2,000 to 50,000, more preferably 5,000 to 40,000, and particularly preferably 10,000 to 30,000. In the present specification, a molecular weight of a polymer refers to a weight-average molecular weight unless otherwise specified. The weight-average molecular weight is measured by gel permeation chromatography (GPC), and is a weight-average molecular weight obtained by conversion using a calibration curve of standard polystyrene.

The (a) (meth)acrylic oligomer is not particularly limited. However, examples thereof include (meth)acrylate oligomer having polyurethane in the backbone, (meth)acrylate oligomer having polyisoprene in the backbone, and (meth)acrylate oligomer having polybutadiene in the backbone. One or more kinds of the (meth)acrylate oligomers can be used.

Examples of the (meth)acrylate oligomer having polyurethane in the backbone include aliphatic urethane (meth)acrylate oligomers (excluding rubber-based and hydrogenated rubber-based ones which are described below), one or more rubber-based urethane (meth)acrylate oligomers based on rubber selected from the group consisting of polybutadiene and polyisoprene, one or more hydrogenated-rubber-based urethane (meth)acrylate oligomers based on hydrogenated rubber selected from the group consisting of hydrogenated polybutadiene and hydrogenated polyisoprene, polyether-based urethane (meth)acrylate oligomers, polycarbonate-based urethane (meth)acrylate oligomers, polyester-based urethane (meth)acrylate oligomers, and combinations thereof.

Examples of a commercially available product of the (meth)acrylate oligomer having polyurethane in the backbone include UV-3700B (manufactured by Nihon Gosei Kako Co., Ltd.: molecular weight of 38,000), UA10000B (manufactured by KSM Co., LTD.: molecular weight of 25,000), UN7700 (manufactured by Negami Chemical Industrial Co., Ltd: molecular weight of 20,000), UN-9200A (manufactured by Negami Chemical Industrial Co., Ltd: molecular weight of 15,000), UN-9000H (manufactured by Negami Chemical Industrial Co., Ltd: molecular weight of 5,000), and EB230 (manufactured by DAICEL-CYTEC Company Ltd.: molecular weight of 5,000).

The (meth)acrylate oligomer having polyisoprene in the backbone and the (meth)acrylate oligomer having polybutadiene in the backbone may be hydrogenated products. Commercially available products may be used as the (meth)acrylate oligomer having polybutadiene in the backbone and the (meth)acrylate oligomer having polyisoprene in the backbone. Examples of the commercially available product of the (meth)acrylate oligomer having polyisoprene in the backbone include UC-1 (manufactured by Kuraray Co., Ltd.: molecular weight of 25,000) and UC-203 (manufactured by Kuraray Co., Ltd.: molecular weight of 35,000). In the present specification, the (meth)acrylate oligomer having polyisoprene in the backbone and the (meth)acrylate oligomer having polybutadiene in the backbone have no urethane bonds.

The (a) (meth)acrylate oligomer is preferably the (meth)acrylate oligomer having polyurethane in the backbone, and more preferably one or more selected from the group consisting of polyether-based urethane (meth)acrylate oligomers, polyester-based urethane (meth)acrylate oligomers, aliphatic urethane (meth)acrylate oligomers, rubber-based urethane (meth)acrylate oligomers, and hydrogenated-rubber-based urethane (meth)acrylate oligomers.

The (b) (meth)acrylic monomer is not particularly limited as long as the (b) (meth)acrylic monomer is a monomer having one or more (meth)acryloyl groups in a molecule. However, the (b) (meth)acrylic monomer is preferably a monofunctional (meth) acrylate monomer. One or more kinds of the (b) (meth)acrylic monomers may be used.

The monofunctional (meth)acrylate monomer is not particularly limited as long as the monofunctional (meth)acrylate monomer is a (meth)acrylate compound having one (meth)acryloyl group in a molecule. Examples of the monofunctional (meth)acrylate monomer include alkyl (meth)acrylates, hydroxy group-containing (meth)acrylates, alicyclic (meth)acrylates, aromatic (meth)acrylates, and heterocyclic (meth)acrylates.

The alkyl (meth)acrylate is not particularly limited. Examples of the alkyl (meth)acrylate include n-butyl(meth)acrylate, i-butyl(meth)acrylate, t-butyl(meth)acrylate, 2-ethylhexyl(meth)acrylate, isooctyl(meth)acrylate, isodecyl(meth)acrylate, lauryl(meth)acrylate, stearyl(meth)acrylate, and isostearyl (meth)acrylate.

The alkyl (meth)acrylate is preferably C₆ to C₃₀ alkyl (meth)acrylate from the viewpoint of imparting flexibility to the photocurable resin layer, more efficiently reducing the viscosity of the photocurable resin composition having not been cured, and reducing odor of the composition. The C₆ to C₃₀ alkyl is linear or branched, and is preferably branched from the viewpoint of excellent adhesive force. The number of carbon atoms in the C₆ to C₃₀ alkyl is preferably 6 to 20 and more preferably 8 to 16.

The hydroxy group-containing (meth)acrylate is not particularly limited. Examples of the hydroxy group-containing (meth)acrylate include hydroxy-substituted alkyl (meth)acrylates such as 2-hydroxyethyl(meth)acrylate, 2-hydroxypropyl(meth)acrylate, 2-hydroxybutyl(meth)acrylate, and 4-hydroxybutyl (meth)acrylate, and hydroxy group-containing (meth)acrylates such as 2-(meth)acryloyloxyethyl-2-hydroxypropyl phthalate, 2-hydroxy-3-(meth)acryloyloxypropyl (meth)acrylate, caprolactone-modified 2-hydroxyethyl(meth)acrylate, and cyclohexanedimethanol mono(meth)acrylate other than hydroxy-substituted alkyl (meth)acrylates.

The alicyclic (meth)acrylate is not particularly limited. Examples of the alicyclic (meth)acrylate include dicyclopentenyloxyethyl (meth)acrylate, norbornene(meth)acrylate, dicyclopentanyl(meth)acrylate, and isobornyl(meth)acrylate.

The aromatic (meth)acrylate is not particularly limited. Examples of the aromatic (meth)acrylate include benzyl(meth)acrylate, phenyl(meth)acrylate, phenoxyethyl(meth)acrylate, and phenoxybenzyl(meth)acrylate.

The heterocyclic (meth)acrylate is not particularly limited. Examples of the heterocyclic (meth)acrylate include tetrahydrofurfuryl (meth)acrylate, (2-methyl-2-ethyl-1,3-dioxolane-4-yl)methyl(meth)acrylate, (3-ethyloxetan-3-yl)methyl(meth)acrylate, pentamethylpiperidyl(meth)acrylate, and tetramethylpiperidyl (meth)acrylate.

The (b) (meth)acrylic monomer preferably includes alicyclic (meth)acrylate, hydroxy group-containing (meth)acrylate, and the heterocyclic (meth)acrylate from the viewpoint of more excellent adhesive force between the first and the second bases, and the photocurable resin layer.

The (c) photo radical polymerization initiator accelerates curing of the photocurable resin composition. One or more kinds of the (c) photo radical polymerization initiators can be used.

The (c) photo radical polymerization initiator is not particularly limited as long as the (c) photo radical polymerization initiator is a compound that allows radicals to be generated by application of light. Examples of the photo radical polymerization initiator include: carbonyl group-based photopolymerization initiators such as benzophenone, diacetyl, benzil, benzoin, ω-bromoacetophenone, chloroacetone, acetophenone, 2,2-diethoxyacetophenone, 2,2-dimethoxy-2-phenylacetone, p-dimethylaminoacetophenone, p-dimethylaminopropiophenone, 2-chlorobenzophenone, p,p′-bis(diethylamino)benzophenone, Michler's ketone, benzoin methyl ether, benzoin isobutyl ether, benzoin-n-butyl ether, benzil dimethylketal, 1-hydroxycyclohexyl phenyl ketone, 2-hydroxy-2-methyl-1-one, 1-(4-isopropylphenyl)-2-hydroxy-2-methylpropane-1-one, methylbenzoyl formate, 2,2-diethoxyacetophenone, and 4-N,N′-dimethylacetophenone; sulfide-based photopolymerization initiators such as diphenyl disulfide and dibenzyl disulfide; quinone-based photopolymerization initiators such as benzoquinone and anthraquinone; ultraviolet light initiators such as azo-based photopolymerization initiators the examples of which include azobisisobutyronitrile and 2,2′-azobispropane; and visible light initiators such as 2-benzyl-2-dimethylamino-1-(4-morpholinophenyl)-butane-1-one, 2-dimethylamino-2-(4-methyl-benzyl)-1-(4-morpholinophenyl)-butane-1-one, bis(2,4,6-trimethylbenzoyl)-phenylphosphine oxide, and 2,4,6-trimethylbenzoyl-diphenylphosphine oxide.

As the (c) photo radical polymerization initiator, the carbonyl group-based photopolymerization initiators are preferable from the viewpoint of enhancing curing speed and reducing coloring after photo-curing.

### Other Configurations

The specimen analysis cartridge of the present embodiment may include components other than the first base, the second base, and the photocurable resin layer. Examples of such a component include the third base, liquid such as a reagent and washing liquid, and a magnetic particle.

The specimen analysis cartridge of the present embodiment may include the third base. The third base may be, for example, disposed on a portion, of the first base, which does not oppose the second base, and may be adhered by the photocurable resin layer. The third base may be adhered through the photocurable resin layer to a portion at which the unsealing mechanism of the first base is formed. In this configuration, the third base may be a urethane film from the viewpoint of high flexibility.

The specimen analysis cartridge of the present embodiment may be filled with liquid such as a reagent and washing liquid. The liquid may be filled in a sealed space enclosed by the first base and the second base in an unused specimen analysis cartridge. In this case, when the specimen analysis cartridge is used, the liquid may be introduced into the micro flow path or the chamber by pressing the unsealing mechanism formed in the first base.

The specimen analysis cartridge of the present embodiment may include a magnetic particle. The magnetic particle may be disposed in the chamber formed in the first base. The magnetic particle may have a function of moving a test substance in a specimen from one chamber to another chamber in analysis of the specimen. For example, a substance that binds to a test substance may be fixed to a surface of the magnetic particle, and the substance may be an antigen or an antibody.

The specimen analysis cartridge of the present embodiment will be described below in detail.

### First Embodiment

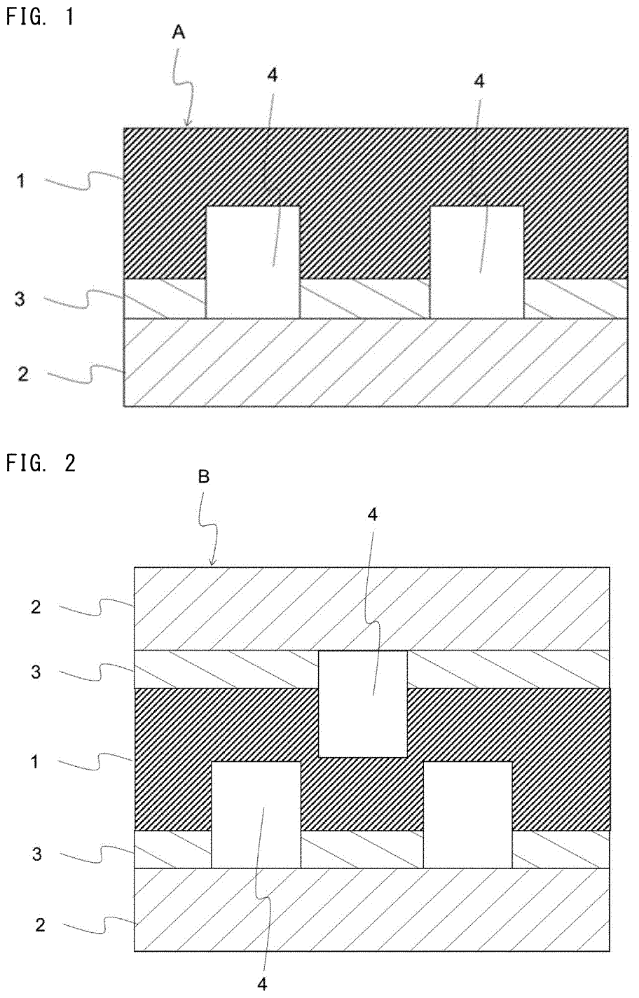

FIG. 1 is a schematic cross-sectional view of a specimen analysis cartridge A of a first embodiment. As shown in FIG. 1, the specimen analysis cartridge A includes a first base 1 having a micro flow path 4 formed at one surface, a second base 2 disposed so as to oppose a surface at which the micro flow path of the first base is formed, and a photocurable resin layer 3 for adhering the first base 1 and the second base 2 to each other. The photocurable resin layer is formed on one surface of the first base 1 merely at a portion at which the micro flow path 4 is not formed. The micro flow path 4 is formed at the first base 1 and is covered by the second base 2, whereby the micro flow path 4 functions as a flow path.

### Second Embodiment

FIG. 2 is a schematic cross-sectional view of a specimen analysis cartridge B of a second embodiment. As shown in FIG. 2, the specimen analysis cartridge B includes the first base 1 having the micro flow paths 4 formed at both surfaces, two second bases 2 disposed so as to oppose both the surfaces of the first base, and two photocurable resin layers 3 for adhering the first base 1 and the second bases 2. The photocurable resin layers are formed at both the surfaces of the first base 1 merely at portions at which the micro flow paths 4 are not formed. The micro flow paths 4 are formed at the first base 1 and are covered by the second bases 2, whereby the micro flow paths 4 each function as a flow path.

### Third Embodiment

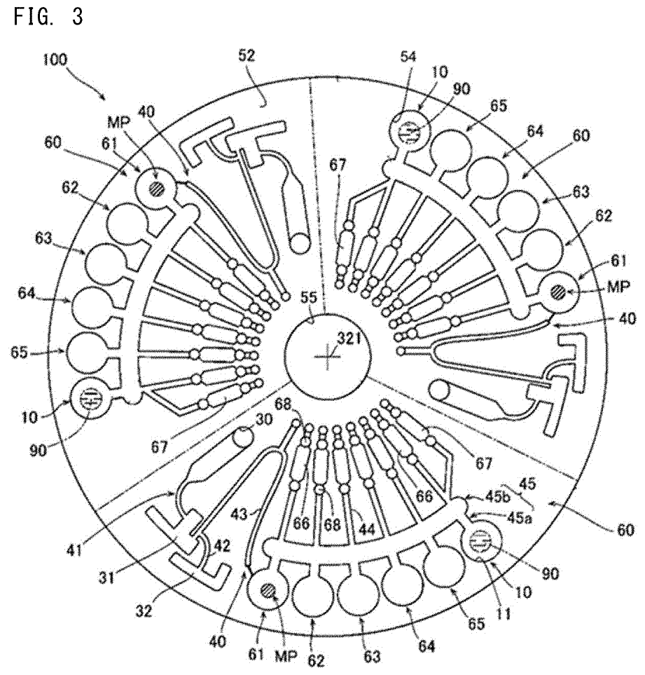

FIG. 3 is a schematic plan view of a specimen analysis cartridge 100 of a third embodiment. The specimen analysis cartridge 100 has a flat-plate-like shape. The specimen analysis cartridge 100 rotates around a rotation axis 321. Specifically, the specimen analysis cartridge 100 is a disk-shaped cartridge formed of a disk-shaped plate-like base. The specimen analysis cartridge 100 is configured as a specimen processing cartridge that can perform a process for detecting a test substance in a specimen by utilizing an antigen-antibody reaction.

A specimen containing a test substance is received by the specimen analysis cartridge 100, and is processed inside the specimen analysis cartridge 100, whereby a measurement sample 90 can be prepared. That is, the specimen analysis cartridge 100 shown in FIG. 3 includes a plurality of processing regions 60 each of which includes one detection chamber 10, and a micro flow path 40 for transferring a test substance to the detection chamber 10. In an example in FIG. 3, the specimen analysis cartridge 100 includes three processing regions 60. Each of the three processing regions 60 includes one detection chamber 10 and the micro flow path 40. Respective spaces of the three processing regions 60 are fluidly separated from each other. The measurement sample 90 is analyzed by fluorescence analysis or chemiluminescent immunoassay, whereby the test substance in the specimen can be quantitatively determined. An example in which the measurement sample 90 is analyzed by chemiluminescent immunoassay will be described below in detail. However, the analysis method is not limited thereto.

The plurality of processing regions 60 are disposed so as to almost equally divide the specimen analysis cartridge 100 on the surface. In the example in FIG. 3, the three processing regions 60 are disposed so as to equally divide the disk-shaped specimen analysis cartridge 100 into three in the circumferential direction. Each processing region 60 is formed as a region extending from the center of the specimen analysis cartridge 100 so as to form a sector in about a 120° range.

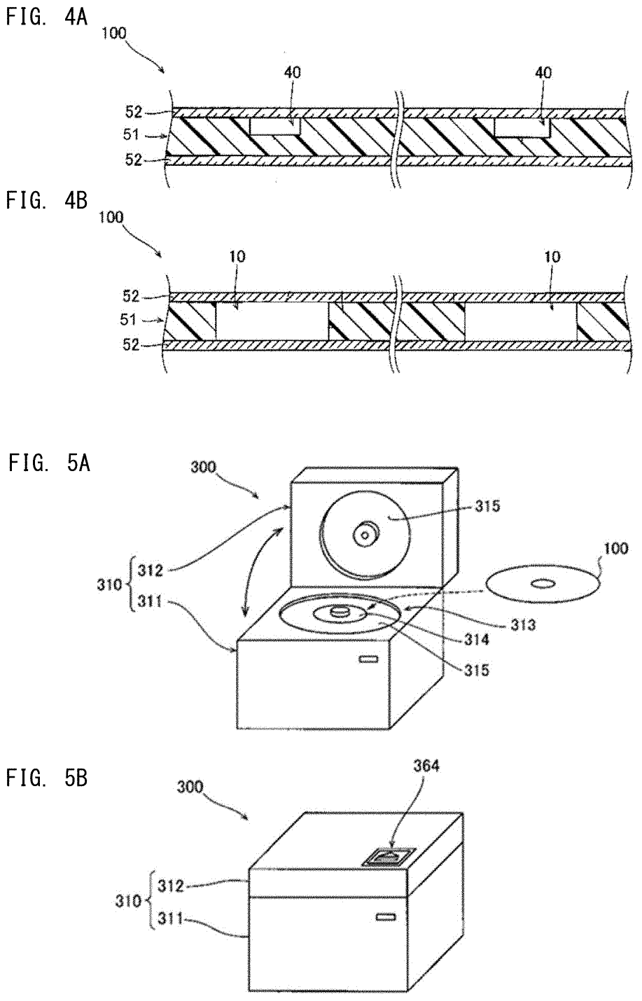

FIG. 4 is a schematic cross-sectional view of the specimen analysis cartridge 100. As shown in FIG. 4A, in a part of the specimen analysis cartridge 100, the micro flow paths 40 are formed at one surface or both surfaces of the first base 51. Second bases 52 are adhered through photocurable resin layers to both surfaces of the first base 51. As shown in FIG. 4B, in a part of the specimen analysis cartridge 100, through holes that penetrate through the first base 51 are formed. The through hole has upper and lower opening ends sealed by the second bases 52 that are disposed on both the surfaces of the first base 51, thereby forming a chamber. In FIG. 4B, the chamber is the detection chamber 10.

A specific configuration of the processing region 60 will be described. In the example of the configuration in FIG. 3, the three processing regions 60 have the same configuration. Therefore, one of the processing regions 60 will be described, and description for the remaining processing regions 60 is omitted.

The processing region 60 includes a separator 31 and a collection part 32, five processing chambers 61 to 65, one detection chamber 10, the micro flow path 40, six liquid storage portions 66, one liquid storage portion 67, and an introduction inlet 30. A specimen is injected from the introduction inlet 30. The specimen is, for example, a whole blood specimen collected from a subject.

The micro flow path 40 fluidly connects the introduction inlet 30, each of the processing chambers 61 to 65, the liquid storage portions 66 and 67, and the detection chamber 10. The micro flow path 40 of each processing region 60 is not fluidly connected to the micro flow paths 40 of the other processing regions 60. The micro flow path 40 includes a plurality of micro flow paths 41 to 45 that fluidly connect components of the processing region 60 to each other.

The processing chambers 61 to 65 are fluidly connected to the detection chamber 10 through the micro flow path 40. The processing chambers 61 to 65 of one of the processing regions 60 are not fluidly connected to the processing chambers 61 to 65 of the other processing regions 60.

The separator 31, the collection part 32, and the processing chambers 61 to 65 each form a space in which liquid can be stored. The separator 31, the collection part 32, and the processing chambers 61 to 65 are each demarcated by a wall portion 54. The separator 31, the collection part 32, the processing chambers 61 to 65, and the detection chamber 10 are aligned in the circumferential direction near the outer circumference of the specimen analysis cartridge 100.

The separator 31 is connected to the introduction inlet 30 through the micro flow path 41. A specimen injected from the introduction inlet 30 is transferred through the micro flow path 41 to the separator 31 by centrifugal force generated by rotation of the specimen analysis cartridge 100.

The collection part 32 is disposed outward of the separator 31 in the radial direction, and is connected through the micro flow path 42 to the separator 31. The specimen flowing through the micro flow path 41 to the separator 31 is sequentially stored from the outer side in the radial direction by centrifugal force. When the specimen stored in the separator 31 reaches the micro flow path 42, an amount of the specimen stored after that is moved to the collection part 32 by the action of the centrifugal force. Thus, a certain amount of the specimen is quantitatively stored in the separator 31.

The specimen processing performed in the processing region 60 includes a process for separating a component contained in the specimen into a liquid component and a solid component. The specimen in the separator 31 is centrifuged by centrifugal force generated by rotation of the specimen analysis cartridge 100 and separated into plasma as a liquid component and non-liquid components such as blood cells that are solid components. The plasma separated by the separator 31 is moved to the micro flow path 43 by capillary phenomenon. The micro flow path 43 is narrowed at a connection portion immediately preceding the processing chamber 61, and the micro flow path 43 is filled with the plasma up to a portion immediately preceding the processing chamber 61.

The micro flow path 43 is connected to the processing chamber 61. Centrifugal force is applied by rotation of the specimen analysis cartridge 100 in a state where the micro flow path 43 is filled with the plasma, whereby the plasma in the micro flow path 43 is transferred to the processing chamber 61. A predetermined amount of the plasma to be transferred to the processing chamber 61 is quantitatively determined according to a volume of the micro flow path 43.

In the example of the configuration in FIG. 3, the processing chambers 61 to 65 and the detection chamber 10 are aligned adjacent to each other in the circumferential direction, and connected to each other through the micro flow path 45 extending in the circumferential direction. A test substance is transferred sequentially one by one among the processing chambers 61 to 65 and the detection chamber 10 from one side (the processing chamber 61 side) toward the other side (the detection chamber 10 side) through the micro flow path 45. To each of the processing chambers 61 to 65 and the detection chamber 10, a reagent stored in the corresponding liquid storage portion 66 is individually transferred through the micro flow path 44.

Liquid containing a test substance is transferred through the micro flow path 43 to the processing chamber 61. A magnetic particle MP is enclosed in the processing chamber 61. In the processing chamber 61, the test substance contained in the specimen binds to the magnetic particle MP. Therefore, at and after the processing chamber 61, the test substance bound to the magnetic particle MP is transferred through the micro flow path 40 to another processing chamber by combination of rotation of the specimen analysis cartridge 100 and action of magnetic force.

The micro flow path 45 includes six radial regions 45a extending in the radial direction, and an arc-shaped circumferential region 45b extending in the circumferential direction. The circumferential region 45b is connected to the six radial regions 45a. Five radial regions 45a in the six radial regions 45a are connected to the corresponding five processing chambers 61 to 65, respectively, and the remaining one radial region 45a is connected to one detection chamber 10. The six liquid storage portions 66 are connected to the micro flow path 45 through the micro flow paths 44, respectively, extending in the radial direction. The six liquid storage portions 66 are aligned with the corresponding processing chambers 61 to 65 and detection chamber 10, respectively, in the radial direction. The liquid storage portion 67 is connected to the micro flow path 44 connecting between the detection chamber 10 and the liquid storage portion 66, through a micro flow path extending mainly in the radial direction. The seven liquid storage portions 66, 67 in total are disposed on the inner circumferential side of the specimen analysis cartridge 100, and the processing chambers 61 to 65 and the detection chamber 10 are disposed on the outer circumferential side of the specimen analysis cartridge 100.

Each of the liquid storage portions 66 and the liquid storage portion 67 stores a reagent and includes one unsealing mechanism 68 on an upper surface of each of both end portions in the radial direction. The unsealing mechanism 68 is pressed from the upper side by an unsealing portion of a detection apparatus 300, and can be thus unsealed. Before the unsealing mechanism 68 is unsealed, a reagent in the liquid storage portion 66 does not flow into the micro flow path 44. When the unsealing mechanism 68 has been unsealed, the reagent in the liquid storage portion 66 flows out into the micro flow path 44. The reagent is moved to the corresponding one of the processing chambers 61 to 65 and the detection chamber 10 by centrifugal force when the specimen analysis cartridge 100 is rotated.

Each of the liquid storage portions 66 and the liquid storage portion 67 previously stores a reagent with which one-time measurement can be performed. That is, the specimen analysis cartridge 100 includes the liquid storage portions 66 and 67 each storing a reagent with which a test substance can be measured one time.

The above-described configuration of the specimen analysis cartridge 100 is illustrative, and may be modified as appropriate. For example, the number and arrangement of the processing regions, the number, the sizes, and arrangement of the chambers, the number, the sizes, and arrangement of the flow paths, and the like may be changed as appropriate. The micro flow path and the chambers may be formed merely at one surface of the first base 51 or may be formed at both surfaces thereof. In a case where the unsealing mechanism 68 is provided, the micro flow path and the chambers are preferably formed at both surfaces of the first base 51.

### Usage

The specimen analysis cartridge of the present embodiment is used for detecting, analyzing, and/or quantitatively determining a test substance in a specimen. Fluorescence analysis or chemiluminescent immunoassay may be performed in the specimen analysis cartridge by introducing a specimen into the specimen analysis cartridge and performing various chemical treatments in the micro flow path and the chambers of the specimen analysis cartridge.

An analysis method using the specimen analysis cartridge 100 of the third embodiment will be described below. Also in the first embodiment and the second embodiment, a specimen can be analyzed in the same or a similar method.

FIG. 5 is a schematic perspective view of an example of a detection apparatus for analyzing a specimen by using the specimen analysis cartridge according to the present embodiment.

The detection apparatus 300 performs measurement by using the disk-shaped specimen analysis cartridge 100. The detection apparatus 300 is an apparatus that executes the analysis method described below and performs photodetection. For example, the detection apparatus 300 is an immunoassay apparatus that uses the specimen analysis cartridge 100 to detect a test substance in a specimen by utilizing antigen-antibody reaction, and measure the test substance based on the detection result.

In an example of a configuration in FIG. 5, the detection apparatus 300 includes a housing 310 in which a light detector is stored. The housing 310 is formed by, for example, a box-shaped member having a predetermined volume of internal space, or by combination of a frame and an external plate. The housing 310 of the detection apparatus 300 for PoC test has a small box-like shape and can be placed on a table.

The housing 310 includes a base portion 311 and a lid portion 312. The lid portion 312 is disposed so as to cover almost the entire surface of the upper surface portion of the base portion 311. A placement portion 313 on which the specimen analysis cartridge 100 is placed is disposed at the upper surface portion of the base portion 311. The lid portion 312 pivots relative to the base portion 311, and is openable and closable between a state shown in FIG. 5A in which the placement portion 313 is opened and a state shown in FIG. 5B in which the placement portion 313 is covered. The housing 310 functions as a dark box configured to shield the specimen analysis cartridge 100 from external light in a state where the placement portion 313 having the specimen analysis cartridge 100 placed thereon is covered by the lid portion 312. The lid portion 312 has an operation portion 364 disposed on the upper surface. Through the operation portion 364, the detection apparatus 300 is caused to perform a predetermined process and immunoassay can be performed by using the specimen analysis cartridge 100.

The placement portion 313 forms the upper surface portion of the base portion 311 that is covered by the lid portion 312 so as to be openable and closable. A support member 314 for supporting the specimen analysis cartridge 100 from the lower side is disposed in the placement portion 313. The support member 314 is, for example, implemented by a turn table. The support member 314 is configured to support the specimen analysis cartridge 100 at a predetermined relative rotation angle.

The detection apparatus 300 rotates the specimen analysis cartridge 100, operates a magnet disposed on the rear surface (that is, inside of the base portion 311) of the support member 314, and detects light emitted from the measurement sample 90, thereby analyzing a specimen introduced into the specimen analysis cartridge 100. A measurement process will be specifically described below.

The measurement process includes transfer of liquid. In the analysis using the specimen analysis cartridge 100, for example, the specimen analysis cartridge 100 is rotated around the rotation axis 321 shown in FIG. 3, and centrifugal force acts on liquid, thereby transferring the liquid. Therefore, the specimen analysis cartridge 100 has, at the center thereof, a hole 55 that penetrates through the specimen analysis cartridge 100. The specimen analysis cartridge 100 is disposed in the detection apparatus 300 such that the center of the hole 55 coincides with the center of the rotation axis 321. The specimen analysis cartridge 100 may have a rotation shaft instead of the hole 55. In this case, the rotation shaft of the specimen analysis cartridge 100 is received and supported by the detection apparatus 300.

The measurement process includes a process for transferring the magnetic particle MP bound to a test substance from one processing chamber to another processing chamber or the detection chamber 10. For example, the magnetic particle MP is moved by magnetic force between inside of the processing chamber 61 and the circumferential region 45b in the radial direction. By rotating the specimen analysis cartridge 100, the magnetic particle MP is moved in the arc-shaped circumferential region 45b in the circumferential direction. The magnetic particle MP carrying the test substance is sequentially moved to the processing chambers 61 to 65 and the detection chamber 10 by combination of movement in the radial direction by the action of magnetic force, and movement in the circumferential direction by rotation.

The measurement process includes a process for stirring the test substance and the reagent inside at least one of the processing chambers 61 to 65 and the detection chamber 10 by rotation of the specimen analysis cartridge 100. That is, the rotation speed of the specimen analysis cartridge 100 is changed and acceleration and deceleration are alternately repeated. By the acceleration and the deceleration, liquid is moved forward and backward in the chamber in the circumferential direction, and a complex is dispersed in the reagent.

In the specimen analysis cartridge 100, after the magnetic particle MP is caused to carry the test substance in the processing chamber 61, the test substance is mixed with the reagent in each of the processing chambers 62, 63, 64, and 65. The processes in the processing chambers 61 to 65 are set according to assay for detecting the test substance. For example, the process in which a reagent is used is a process for binding the test substance and a labelling substance to each other. Finally, the magnetic particle MP carrying the test substance and the labelling substance is moved to the detection chamber 10.

In the analysis using the specimen analysis cartridge 100, a plurality of the detection chambers 10 are disposed at positions on the outer circumferential side of the specimen analysis cartridge 100 around the rotation axis 321. Thus, centrifugal force generated when the specimen analysis cartridge 100 is rotated can be utilized to send liquid to the detection chambers 10. For example, liquid that is sent to each of the detection chambers 10 by rotation of the specimen analysis cartridge 100 is a luminescent substrate. That is, the specimen analysis cartridge 100 includes a plurality of the liquid storage portions 67 that are fluidly connected to the plurality of the detection chambers 10, respectively, and the liquid storage portion 67 is filled with a luminescent substrate that causes light to be generated from the measurement sample 90. Therefore, a luminescent substrate is sent to each of the detection chambers 10 from the corresponding liquid storage portion 67. As a result of sending the luminescent substrate, the measurement sample 90 that causes chemiluminescence is prepared in the detection chamber 10.

The luminescent substrate is disposed in the liquid storage portion 67 in advance when the specimen analysis cartridge 100 is manufactured. The luminescent substrate may be injected, by a user, into the liquid storage portion 67 in an empty state, when the specimen analysis cartridge 100 is used.

The measurement process includes detection of light that is generated from the measurement sample 90 prepared in the detection chamber 10. The detection is performed by a light detector disposed in the detection apparatus 300.

In the example in FIG. 3, the three processing regions 60 are each formed in a region that is one-third of the specimen analysis cartridge 100. However, the configuration is not limited thereto. The number of the processing regions 60 formed therein may be two or less, or four or more. The number and the shapes of the processing chambers and the number and the shapes of the micro flow paths are not limited to those shown in FIG. 3. The configuration of each component of the processing region 60 is determined according to the specimen processing assay executed in the processing region 60.

The specimen analysis cartridge 100 stores a reagent that is disposable after used only once. In this case, it is difficult to control accuracy of the specimen analysis cartridge 100 by measuring a control substance with use of the stored reagent. Visual confirmation may be made from the outside for confirming that the process has been properly performed in the specimen analysis cartridge 100 in order to control accuracy, instead of the measurement of a control substance. The visual confirmation includes not only visual confirmation of the specimen analysis cartridge 100 which is performed by a user, but also confirmation performed by taking an image of the specimen analysis cartridge 100 by an imaging portion.

In the above-described embodiment, chemiluminescence is light emitted by using energy caused by chemical reaction, and is, for example, light that is emitted when molecules excited by chemical reaction into an excited state are returned from the excited state to a ground state. For example, the chemiluminescence can be generated by reaction between an enzyme and a substrate, can be generated by applying electrochemical stimuli to a labelling substance, can be generated by LOCI (luminescent oxygen channeling immunoassay), or can be generated according to bioluminescence. In the present embodiment, the chemiluminescence may be of any type. A complex may be formed by binding a test substance and a substance which is excited to generate fluorescence when light having a predetermined wavelength is applied. In this case, a light source for applying light to the detection chamber 10 is disposed in the base portion 311. The light detector detects fluorescence that is generated when the substance bound to the complex is excited by the light from the light source.

The magnetic particle MP may be any particle that contains a magnetic material as a base and is used for standard immunoassay. For example, a magnetic particle containing, as the base, Fe₂O₃ and/or Fe₃O₄, cobalt, nickel, ferrite, magnetite, or the like, can be used. The magnetic particle may be coated with a binding substance for binding to a test substance, or may bind to a test substance by means of a capture substance for binding the magnetic particle and the test substance to each other. The capture substance is an antigen, an antibody, or the like that binds the magnetic particle and the test substance mutually to each other.

The capture substance is not particularly limited as long as the capture substance specifically binds to a test substance. For example, the capture substance binds to a test substance by an antigen-antibody reaction. More specifically, the capture substance is, for example, an antibody. When the test substance is an antibody, the capture substance may be an antigen of the antibody. When the test substance is a nucleic acid, the capture substance may be a nucleic acid that is complementary to the test substance. Examples of the label contained in the labelling substance include an enzyme and a fluorescent substance. Examples of the enzyme include alkaline phosphatase (ALP), peroxidase, glucose oxidase, tyrosinase, and acid phosphatase. When chemiluminescence is electrochemiluminescence, the label is not particularly limited as long as the label is a substance that emits light by electrochemical stimuli. Examples of the label include a ruthenium complex. Examples of the fluorescent substance include fluorescein isothiocyanate (FITC), green fluorescent protein (GFP), and luciferin.

Furthermore, when the label is an enzyme, a luminescent substrate for the enzyme may be selected from known luminescent substrates as appropriate according to the enzyme to be used. For example, in a case where alkaline phosphatase is used as the enzyme, examples of the luminescent substrate include: chemiluminescent substrates such as CDP-Star (registered trademark), (disodium 4-chloro-3-(methoxyspiro[1,2-dioxetane-3,2′-(5′-chloro)tricyclo[3.3.1.13,7]decane]-4-yl)phenylphosphate), and CSPD (registered-trademark) (disodium 3-(4-methoxyspiro[1,2-dioxetane-3,2-(5′-chloro)tricyclo[3.3.1.13,7]decane]-4-yl)phenylphosphate); luminescent substrates such as p-nitrophenyl phosphate, 5-bromo-4-chloro-3-indolyl phosphate (BCIP), 4-nitro blue tetrazolium chloride (NBT), and iodonitrotetrazolium (INT); fluorescent substrates such as 4-methylumbelliferyl phosphate (4MUP); chromogenic substrates such as 5-bromo-4-chloro-3-indolyl phosphate (BCIP), disodium 5-bromo-6-chloro-indolyl phosphate, and p-nitrophenyl phosphate; and the like.

### Method for Manufacturing Specimen Analysis Cartridge

The specimen analysis cartridge of the present embodiment can be manufactured by bringing the first base and the second base into contact with each other through the photocurable resin composition, and thereafter applying light to the photocurable resin composition and curing the photocurable resin composition. The method for manufacturing the specimen analysis cartridge of the present embodiment will be described below in detail. However, the specimen analysis cartridge of the present embodiment may be manufactured in a method other than the manufacturing method described below.

The manufacturing method of the present embodiment includes a step of applying the photocurable resin composition to the first base by an inkjet method, a step of adhering the second base to a surface of the first base to which the photocurable resin composition is applied, and a step of applying light to the photocurable resin composition to form the photocurable resin layer. Hereinafter, the above-described steps are referred to as application step, adhering step, and curing step, respectively.

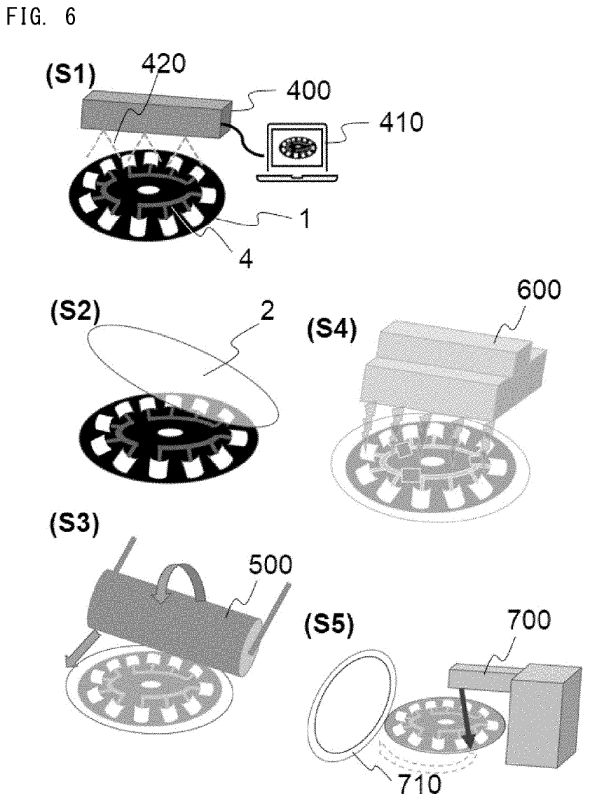

FIG. 6 illustrates an example of the manufacturing method for manufacturing the specimen analysis cartridge according to the present embodiment. Each step of the manufacturing method of the present embodiment will be described below with reference to FIG. 6.

### Application Step

In the application step, the photocurable resin composition is applied to the first base by an inkjet method. As shown in (S1) in FIG. 6, the application step may be a step of applying a photocurable resin composition 420 to at least a surface at which the micro flow path 4 of the first base 1 is formed, in an inkjet method, by using a photocurable resin composition application device 400. The photocurable resin composition application device 400 is controlled by a control unit 410 to apply the photocurable resin composition 420 merely to a predetermined portion of the first base 1.

The control unit 410 reads an application design that is designed in advance in a bitmap format, and controls the photocurable resin composition application device 400 so as to apply the photocurable resin composition 420 according to the application design. The application design is designed by taking into consideration a state where the photocurable resin composition is pressed and spread when the first base and the second base are adhered to each other. More specifically, the design may be performed so as not to apply the photocurable resin composition in a region up to a predetermined distance from a portion at which recesses such as the micro flow path, the chamber, and the through hole are formed in the first base. The predetermined distance is, for example, not less than 50 μm and not greater than 1 mm, not less than 100 μm and not greater than 900 μm, and not less than 300 μm and not greater than 800 μm. Such a distance may be adjusted as appropriate according to, for example, the viscosity of the photocurable resin composition, pressing pressure in the adhering step described below, and a desired thickness of the photocurable resin layer.

The photocurable resin composition application device 400 applies the photocurable resin composition 420 to the first base 1 under the control of the control unit 410. The photocurable resin composition application device is not particularly limited as long as the photocurable resin composition is applied by an inkjet method, and is preferably a mechanical-type inkjet application device in which a piezoelectric element is used. As the inkjet method, for example, a mechanical-type, a thermal-type, and a Hertz-type methods are known. Among them, a mechanical-type method in which a piezoelectric element is used allows precise control of an amount of discharged droplets and positions at which the droplets are discharged. Therefore, by using a mechanical-type inkjet application device in which a piezoelectric element is used, an application portion can be precisely controlled so as not to apply the photocurable resin composition to a region including a portion at which the recesses such as the micro flow path, the chamber, and the through hole are formed, and the peripheral portion thereof. The mechanical-type method in which a piezoelectric element is used is advantageous also in that a composition to be applied need not be heated while the heating is needed in a thermal-type one, and a wide range of the photocurable resin compositions can be thus applied.

The photocurable resin composition is a composition containing a polymerizable compound and a photopolymerization initiator. The photocurable resin composition preferably contains (meth)acrylic resin as the polymerizable compound, and preferably contains a photo radical polymerization initiator as the photopolymerization initiator. The photocurable resin composition more preferably contains (a) (meth)acrylic oligomer having a weight-average molecular weight of not less than 2000, (b) (meth)acrylic monomer, and (c) a photo radical polymerization initiator. Examples and preferable configurations of the (a) (meth)acrylic oligomer, the (b) (meth)acrylic monomer, and the (c) photo radical polymerization initiator are as described above.

The viscosity of the photocurable resin composition is preferably not less than 1.0 mPa·s and is less than 50 mPa·s from the viewpoint of favorably performing application by the inkjet method. The viscosity of the photocurable resin composition is more preferably not less than 5 mPa·s, even more preferably not less than 15 mPa·s, still more preferably not less than 20 mPa·s, and particularly preferably not less than 25 mPa·s, in the above-described range. In a case where the viscosity of the photocurable resin composition is not less than 1.0 mPa·s, the applied photocurable resin composition is inhibited from being spread to a portion other than a portion designed for the first base before curing, and a place at which the photocurable resin layer is formed can be more preferably controlled.

The viscosity of the photocurable resin composition is more preferably not greater than 48 mPa·s, even more preferably not greater than 46 mPa·s, and still more preferably not greater than 45 mPa·s in the above-described range. In a case where the viscosity of the photocurable resin composition is less than 50 mPa·s, the mechanical-type inkjet application device in which a piezoelectric element is used can easily perform the application. The viscosity of the photocurable resin composition may be in a range obtained by discretionarily combining the above-described upper limit value and lower limit value in the above-described range.

### Adhering Step

In the adhering step, the second base is adhered to a surface of the first base to which the photocurable resin composition has been applied. As shown in (S2) and (S3) in FIG. 6, the adhering step may be a step of aligning the second base 2 with the surface of the first base 1 to which the photocurable resin composition has been applied and provisionally adhering the second base 2 to the surface, and thereafter pressing the surfaces of the second base 2 and/or the first base 1 by a roller 500, to pressure-adhere the second base 2 to the first base 1. The pressing pressure by the roller 500 is not particularly limited. However the pressure is, for example, not less than 0.10 MPa and not greater than 10 MPa.

In this step, in a case where the second base 2 has a size slightly larger than the size of the first base 1, alignment in adhesion is facilitated.

### Curing Step

In the curing step, light is applied to the photocurable resin composition to form the photocurable resin layer. As shown in (S4) in FIG. 6, the curing step may be a step of applying light to a laminated body obtained in the adhering step by using a light applying device 600 and curing the photocurable resin composition. A wavelength and intensity of light applied by the light applying device 600 may be selected as appropriate according to characteristics of the photocurable resin composition applied in the application step. In one aspect, the light applying device 600 is an ultraviolet ray applying device, specifically, a metal halide lamp. An accumulated amount of light is, for example, not less than 1,000 mJ/cm² and not greater than 6,000 mJ/cm².

### Other Steps

The manufacturing method of the present embodiment may include steps other than the application step, the adhering step, and the curing step. The manufacturing method of the present embodiment may include, for example, a base forming step, a base cutting step, and a liquid injection step described below.

In the base forming step, the first base and/or the second base are formed. The base forming step may be a step of forming the first base and the second base by molding at least one of the above-described cycloolefin polymer and cycloolefin copolymer in an appropriate method. In the base forming step, a conventionally known resin molding method or MEMS process can be used. For processing the micro flow path, for example, laser drawing, dry etching, wet etching, or the like may be used.

In the cutting step, as shown in (S5) in FIG. 6, in a case where the second base is larger than the first base, a portion 710, of the second base, which has not been adhered to the first base is cut. The portion 710 may be said to be a part of the second base which has protruded in the adhering step. In the cutting step, the portion 710 may be cut out by any method, and is preferably cut out by using a laser processing machine 700 from the viewpoint of high-accuracy cutting.

In the liquid injection step, liquid such as a reagent and washing liquid used for analyzing a specimen is injected in advance into the specimen analysis cartridge. For example, after one of the second bases is adhered to one surface of the first base, the liquid injection step may be performed before the other of the second bases is adhered to the other surface of the first base. The liquid to be injected may be selected as appropriate according to usage of the specimen analysis cartridge.

Although one example of the manufacturing method for manufacturing the specimen analysis cartridge according to the present embodiment has been described above, any of the above-described steps may be modified as appropriate, any of the steps may be omitted, or a step other than the above-described steps may be added.

For example, in a case where the second bases are adhered to both surfaces of the first base, the application step and the adhering step may be repeatedly performed twice. Alternatively, the photocurable resin composition may be applied to both surfaces of the first base at one time in the application step, and the second bases may be thereafter adhered to both the surfaces.

The photocurable resin composition may be applied to the second base in the application step regardless of whether or not the micro flow path is formed in the second base.

### Appendix

The present disclosure includes the following embodiments.

[1]

A specimen analysis cartridge including:
a first base having a micro flow path formed in at least one surface;
a second base disposed so as to oppose a surface at which the micro flow path of the first base is formed; and
a photocurable resin layer for adhering the first base and the second base to each other, in which
the first base and the second base each contain at least one of cycloolefin polymer and cycloolefin copolymer.
   [2]

The specimen analysis cartridge of [1], in which the photocurable resin layer has a thickness of not less than 1.0 μm and not greater than 100 μm.

[3]

The specimen analysis cartridge of [1] or [2], in which the micro flow path has a minimal flow path width of not greater than 200 μm.

[4]

The specimen analysis cartridge of any one of [1] to [3], in which 180° peel strength between the first base and the second base is not less than 15 N/10 mm.

[5]

The specimen analysis cartridge of any one of [1] to [4], in which the photocurable resin layer contains acrylic resin and/or methacrylic resin.

[6]

The specimen analysis cartridge of any one of [1] to [5], in which the photocurable resin layer is a cured product of a photocurable resin composition that contains (a) acrylic oligomer and/or methacrylic oligomer having a weight-average molecular weight of not less than 2000, (b) acrylic monomer and/or methacrylic monomer, and (c) a photo radical polymerization initiator.

[7]

The specimen analysis cartridge of [6], in which the (a) acrylic oligomer and/or methacrylic oligomer has a polyurethane backbone.

[8]

A manufacturing method for manufacturing the specimen analysis cartridge of any one of [1] to [7], the manufacturing method including:
applying a photocurable resin composition to the first base by an inkjet method; adhering the second base to a surface of the first base to which the photocurable resin composition is applied; and
applying light to the photocurable resin composition to form the photocurable resin layer.
   [9]

The manufacturing method of [8], in which the photocurable resin composition has a viscosity of not less than 1.0 mPa·s and less than 50 mPa·s.

### EXAMPLES

The present disclosure will be more specifically described below by means of examples and comparative examples. The present disclosure is not limited to the examples described below in any way.

### Measurement of Viscosity

The viscosity of the photocurable resin composition used in the examples was measured in the following manner.

### Measurement Method

A viscometer (RE105U: manufactured by Toki Sangyo Co., Ltd) was used and an appropriate cone plate and an appropriate rotation speed were selected, whereby the viscosity was measured at 25° C. under an atmospheric pressure.

### Example 1

The specimen analysis cartridge was manufactured by using the following materials and the like.

Cycloolefin polymer: ZEONOR 1060R manufactured by Zeon Corporation Photocurable resin composition: KY-L3 (contained components: (meth)acrylic oligomer having a weight-average molecular weight of not less than 10,000 and not greater than 30,000 and having a polyurethane backbone, (meth)acrylic monomer, and a photo radical polymerization initiator (cleaving type)) manufactured by Kyoritsu Chemical & Co., Ltd.

Firstly, the cycloolefin polymer was injection-molded to form a disk-shaped base (first base) having a diameter of 120 mm and a thickness of 1.2 mm. A micro flow path was formed at one surface of the base so as to have a minimal width of 100 μm, a minimal depth of 100 μm, a maximal width of 9.0 mm, and a maximal depth of 1.2 mm. The micro flow path having a depth of 1.2 mm corresponded to a through hole.

Similarly, the cycloolefin polymer was injection-molded to form a disk-shaped film sheet (second base) having a diameter of 130 mm and a thickness of 0.1 mm.

Subsequently, the above-described photocurable resin composition was applied to a surface of the base having the micro flow path as obtained in the above-described manner. The application was performed by using a mechanical-type inkjet application device in which a piezoelectric element was used. An application pattern was formed in advance in a bitmap format, and was read by the resin application device, whereby the photocurable resin composition was applied merely to a portion at which the micro flow path of the base was not formed. The application pattern of the photocurable resin composition was designed so as to apply the resin composition to a portion other than a region up to 600 μm from the recesses such as the micro flow path, the chamber, and the through hole formed in the base, by taking into consideration a state of the resin composition being spread during adhesion of the base and the film sheet to each other.

Subsequently, the film sheet was adhered to the surface of the base to which the photocurable resin composition was applied. A pressure-adhering device having a roller tool was used to pressure-adhere the film sheet while the roller tool was rotated from one of end side portions so as to form an arc, whereby the base and the film sheet were adhered to each other. At this time, the adhering pressure was controlled to be a constant pressure that was 1.5 MPa.

After the base and the sheet were pressure-adhered to each other, ultraviolet rays were applied through the sheet front surface side, to cure the photocurable resin composition, thereby obtaining the photocurable resin layer. The ultraviolet rays were applied by using a metal halide lamp under conditions that an amount of applied light was 100 mW, an application time was 30 seconds, and an accumulated amount of light was 3,000 mJ/cm². The obtained laminated body was cut, and the cross-section was observed through an optical microscope. According to the observation, the photocurable resin layer was a layer having a constant thickness of not greater than 10 μm.

Subsequently, an appropriate reagent and the like were introduced into the micro flow path from a through hole at a surface, of the base, to which the film sheet was not adhered. Thereafter, the film sheet was adhered also to the surface in the same method as described above. Since a reagent dispensing opening, a specimen introduction inlet, and an unsealing mechanism for controlling flow of the reagent were disposed at this surface, the film sheet was precut so as not to cover these portions.

Thereafter, a polyurethane sheet having a sticky adhesive applied to one side was adhered to the unsealing mechanism and the reagent dispensing opening. A surplus portion of the film sheets adhered to the both surfaces of the base was cut out and removed by a laser processing machine having a carbon dioxide light source, thereby obtaining the specimen analysis cartridge of Example 1. Two specimen analysis cartridges were manufactured by the above-described method.

### Examples 2 to 4

The specimen analysis cartridges of Examples 2 to 4 were each manufactured in the same manner as in Example 1 except that a composition of the photocurable resin composition was slightly adjusted.

### Reference Examples 1 to 2

The specimen analysis cartridges of Reference examples 1 and 2 were each manufactured in the same manner as in Example 1 except that a composition of the photocurable resin composition was slightly adjusted.

### Comparative example 1

Two specimen analysis cartridges were manufactured in the same manner as in Example 1 except that an acrylic adhesive sheet instead of photocurable resin was used for adhering the base and the film sheet to each other.

### Test Method

The following tests were conducted, and performance of each of the specimen analysis cartridges of Examples 1 to 4, Reference examples 1 and 2, and Comparative example 1 was evaluated.

### As to Whether or not Inkjet Application was able to be Performed and as to Film Formation Performance

Whether or not the photocurable resin composition was able to be applied by an inkjet method was determined for evaluation in formation of the photocurable resin layer. Film formation performance of the photocurable resin composition was evaluated according to the following criteria in a case where the photocurable resin composition was able to be applied by the inkjet method.

### Criteria

A: The applied photocurable resin composition was left stationary at a desired position until it was cured.
C: The applied photocurable resin composition was spread beyond the desired position before it was cured.

### Test for Durability Against Liquid Leakage

The liquid leakage time of the specimen analysis cartridge was measured as described below, and durability against liquid leakage was evaluated according to the following criteria.

### Measurement Method

The specimen analysis cartridge was left stationary on a hot plate at 60° C., and one image was obtained every one second by using a USB microscope. Whether or not liquid leakage of the reagent charged in advance occurred was determined by visual observation through the microscope and observation through contact.

### Criteria

A: A liquid leakage endurance time was not shorter than ten minutes, and durability against liquid leakage was high.
B: A liquid leakage endurance time was not shorter than two minutes and was shorter than ten minutes, and durability against liquid leakage was at a medium level.
C: A liquid leakage endurance time was shorter than two minutes, and durability against liquid leakage was low.

### Measurement of Adhesive Strength

180° peel strength between the base (first base) and the film sheet (second base) in the specimen analysis cartridge was calculated as described below, and was evaluated according to the following criteria.

### Measurement Method

The cycloolefin polymer similar to that of the base and the film sheet in the specimen analysis cartridge was used to produce test sheets each having a width of 10 mm. Two test sheets were adhered by the photocurable resin layer used in each example to produce a test piece, and peel strength was measured by using a peel tester. One sheet bottom surface (surface on a side opposite to the adhesion surface side) of the test piece was fixed to a tester stage, and the end portion of the sheet on the upper side was held by a holding tool connected to a load cell of the measurement machine. Peeling force between the two sheets was measured while the held sheet was pulled at a constant speed in the direction (180°) parallel to the fixed sheet. Thus, a measurement value in the 180° direction tensile test was measured, and the value was set as 180° peel strength in each example. The measurement was performed in accordance with HS K6854-2.

### Criteria

A: Adhesive strength was not less than 25 N/10 mm and adhesive strength was excellent.
B: Adhesive strength was not less than 18 N/10 mm and was less than 25 N/10 mm, and adhesive strength was standard.
C: Adhesive strength was less than 18 N/10 mm and adhesive strength was poor.

### Observation through Optical Microscope

The specimen analysis cartridge was observed through an optical microscope, and presence or absence of protrusion of the photocurable resin layer into the micro flow path was confirmed. The protrusion was evaluated according to the following criteria.

### Criteria

A: Protrusion of the photocurable resin layer was absent.
B: The photocurable resin layer protruded into the micro flow path during analysis (during rotation operation).
C: Protrusion of the photocurable resin layer was present.

### Test Results

Firstly, test for durability against liquid leakage was conducted for the specimen analysis cartridges of Example 1 and Comparative example 1, and comparison in durability against liquid leakage was made. Table 1 indicates observation results based on the elapse of time. In Table 1, “A” represents a case where no liquid leakage occurred, and “C” represents a case where liquid leakage occurred.

As shown in FIG. 3, the manufactured specimen analysis cartridge had three processing regions. Therefore, in Example 1, each of the two manufactured samples was observed in two processing regions (four regions in total). In Table 1, the results indicated in measurement Nos. 1 to 4 as to Example 1 are a result of the first sample in the first processing region, a result of the first sample in the second processing region, a result of the second sample in the first processing region, and a result of the second sample in the second processing region in order, respectively. The results indicated in measurement Nos. 1 and 2 as to Comparative example 1 are a result of the first sample and a result of the second sample in order, respectively.

TABLE 1

| | Adhering | Measurement | 0 | 1 | 2 | 3 | 4 | 5 | 6 | 7 | 8 | 9 | 10 | 60 |
|---|---|---|---|---|---|---|---|---|---|---|---|---|---|---|
| | method | No. | min. | min. | min. | min. | min. | min. | min. | min. | min. | min. | min. | min. |
| Example 1 | Photocurable | 1 | A | A | A | A | A | A | A | A | A | A | A | A |
| | resin layer | 2 | A | A | A | A | A | A | A | A | A | A | A | A |
| | | 3 | A | A | A | A | A | A | A | A | A | A | A | A |
| | | 4 | A | A | A | A | A | A | A | A | A | A | A | A |
| Comparative | Adhesive | 1 | A | A | C | C | C | C | C | C | C | C | C | C |
| example 1 | | 2 | A | A | C | C | C | C | C | C | C | C | C | C |

The above-described results indicate that durability against liquid leakage was low in the specimen analysis cartridge of Comparative example 1 in which the base and the film sheet were adhered by using the adhesive (adhesive sheet), and durability against liquid leakage was high in the specimen analysis cartridge of Example 1 in which the base and the film sheet were adhered by using the photocurable resin.

Subsequently, comparison in performance was made among the specimen analysis cartridges of Examples 1 to 4 and Reference examples 1 and 2 in which compositions of the photocurable resin compositions for forming the photocurable resin layers were different. Table 2 indicates the test results. In Reference examples 1 and 2, since it was difficult to manufacture the specimen analysis cartridge, durability against liquid leakage was not evaluated.

TABLE 2

| | Example | Example | Example | Example | Reference | Reference |
|---|---|---|---|---|---|---|
| | 1 | 2 | 3 | 4 | example 1 | example 2 |
| Viscosity of | 38 | 30 | 45 | 35 | 21 | 50 |
| photocurable resin | | | | | | |
| composition | | | | | | |
| (mPa · s) | | | | | | |
| Whether or not | A | A | A | A | A | C |
| inkjet application | | | | | | |
| was possible | | | | | | |
| Film formation | A | A | A | A | C | — |
| performance | | | | | | |
| Adhesive strength | A | A | A | B | C | B |
| (N/10 mm) | 25.2 | 25.1 | 25.4 | 19.9 | 15.9 | 20.9 |
| Protrusion of | A | A | A | B | C | — |
| photocurable | | | | | | |
| resin layer | | | | | | |
| Durability against | A | A | A | B | — | — |
| liquid leakage | 60< | 60< | 60< | 2 | — | — |
| (min.) | | | | | | |

What is claimed is:

1. A specimen analysis cartridge comprising:
a first base having a micro flow path formed in at least one surface;
a second base disposed so as to oppose a surface at which the micro flow path of the first base is formed; and
a photocurable resin layer for adhering the first base and the second base to each other, wherein
the first base and the second base each contain at least one of cycloolefin polymer and cycloolefin copolymer.

2. The specimen analysis cartridge of claim 1, wherein the photocurable resin layer has a thickness of not less than 1.0 μm and not greater than 100 μm.

3. The specimen analysis cartridge of claim 1, wherein the micro flow path has a minimal flow path width of not greater than 200 μm.

4. The specimen analysis cartridge of claim 1, wherein 180° peel strength between the first base and the second base is not less than 15 N/10 mm.

5. The specimen analysis cartridge of claim 1, wherein the photocurable resin layer contains acrylic resin and/or methacrylic resin.

6. The specimen analysis cartridge of claim 1, wherein the photocurable resin layer is a cured product of a photocurable resin composition that contains (a) acrylic oligomer and/or methacrylic oligomer having a weight-average molecular weight of not less than 2000, (b) acrylic monomer and/or methacrylic monomer, and (c) a photo radical polymerization initiator.

7. The specimen analysis cartridge of claim 6, wherein the (a) acrylic oligomer and/or methacrylic oligomer has a polyurethane backbone.

8. A manufacturing method for manufacturing the specimen analysis cartridge of claim 1, the manufacturing method comprising:
applying a photocurable resin composition to the first base by an inkjet method;
adhering the second base to a surface of the first base to which the photocurable resin composition is applied; and
applying light to the photocurable resin composition to form the photocurable resin layer.

9. The manufacturing method of claim 8, wherein the photocurable resin composition has a viscosity of not less than 1.0 mPa·s and less than 50 mPa·s.
